(19) United States
(12) Patent Application Publication
(10) Pub. No.: US 2025/0129239 A1
(43) Pub. Date: Apr. 24, 2025

(54) RUBBER COMPOSITION FOR PNEUMATIC TIRES AND PNEUMATIC TIRE

(71) Applicant: Toyo Tire Corporation, Itami-shi (JP)

(72) Inventor: Shuhei Yamamoto, Itami-shi (JP)

(73) Assignee: Toyo Tire Corporation, Itami-shi (JP)

(21) Appl. No.: 18/904,218

(22) Filed: Oct. 2, 2024

(30) Foreign Application Priority Data
Oct. 20, 2023 (JP) 2023-180774

(51) Int. Cl. C08L 9/06; B60C 1/00; C08L 7/00

(52) U.S. Cl. CPC C08L 9/06; B60C 1/0016; C08L 7/00; C08L 2205/025; C08L 2207/20; C08L 2207/322

(57) ABSTRACT

A rubber composition for pneumatic tires containing recycled process oil, wherein the recycled process oil has a kinematic viscosity of 5 mm2/s or more as measured at 100° C. It is preferred that the recycled process oil has a number average molecular weight of 500 and a weight average molecular weight of 600 or more. It is preferred that the recycled process oil contains 50% or more of a paraffin component and has a flash point of 250° C. or higher. It is preferred that the recycled process oil has a glass transition point of higher than −80° C. It is preferred that the recycled process oil is derived from compressor operating oil.

### BACKGROUND OF THE INVENTION

### Field of the Invention

The present invention relates to a rubber composition for pneumatic tires and a pneumatic tire.

### Description of the Related Art

A pneumatic tire is mostly made of a vulcanized rubber, and the vulcanized rubber is produced by vulcanizing and molding a rubber composition for pneumatic tires obtained by mixing a filler and sulfur into a rubber component and kneading them. When a compounding agent such as a filler is mixed into a rubber component, a large amount of process oil is conventionally used to smoothly perform kneading. However, from the viewpoint of replacement with a sustainable material, various efforts to replace process oil produced from petroleum with vegetable oil or the like have been made.

Patent Document 1 mentioned below discloses process oil whose kinematic viscosity at 75° C. is 5 mm²/s or more and 100 mm²/s or less, viscosity gravity constant is 0.700 or more and 0.900 or less, absorbance at 198 nm is more than 3 and 3.6 or less, absorbance at 228 nm is 1.6 or more and 3.5 or less, and aniline point is 100° C. or higher and 200° C. or lower.

### PRIOR ART DOCUMENT

### Patent Document

Patent Document 1: JP-B2-7061942

### SUMMARY OF THE INVENTION

The technique disclosed in Patent Document 1 mentioned above is intended to achieve both weatherability and bleed resistance, but process oil produced from petroleum is directly used. Therefore, from the viewpoint of sustainability, there is a room for improvement.

In view of the above circumstances, it is an object of the present invention to provide a rubber composition for pneumatic tires which contains sustainable recycled process oil and can be used as a raw material of a vulcanized rubber having excellent rupture strength and low tan δ.

The above object can be achieved by the following aspects. Specifically, the present invention relates to a rubber composition for pneumatic tires (1) containing recycled process oil, wherein the recycled process oil has a kinematic viscosity of 5 mm²/s or more as measured at 100° C.

The rubber composition for pneumatic tires (1) is preferably a rubber composition for pneumatic tires (2), wherein the recycled process oil has a number average molecular weight of 500 and a weight average molecular weight of 600 or more.

The rubber composition for pneumatic tires (1) or (2) is preferably a rubber composition for pneumatic tires (3), wherein the recycled process oil contains 50% or more of a paraffin component and has a flash point of 250° C. or higher.

Any one of the rubber compositions for pneumatic tires (1) to (3) is preferably a rubber composition for pneumatic tires (4), wherein the recycled process oil has a glass transition point of higher than-80° C.

Any one of the rubber compositions for pneumatic tires (1) to (4) is preferably a rubber composition for pneumatic tires (5), wherein the recycled process oil is derived from compressor operating oil.

The present invention also relates to a pneumatic tire (6) including at least a vulcanized rubber of any one of the rubber compositions for pneumatic tires (1) to (5).

As described above, from the viewpoint of replacement with a sustainable material, various efforts to replace process oil produced from petroleum with vegetable oil or the like have been made. However, in reality, progress of such replacement is slow because rubber compositions for pneumatic tires using vegetable oil are much inferior to rubber compositions for pneumatic tires using conventional process oil in unvulcanized rubber characteristics and vulcanization characteristics. A major reason for this is considered to be that vegetable oil composed of triglyceride and process oil composed of a hydrocarbon such as paraffin are greatly different in composition.

The present inventor has paid attention to recycled process oil produced by recycling used process oil and has intensively studied a rubber composition for pneumatic tires containing recycled process oil capable of preventing deterioration of physical properties of a vulcanized rubber to be finally obtained as compared to unused process oil. As a result, the present inventor has found that a rubber composition for pneumatic tires containing (i) recycled process oil having a kinematic viscosity of 5 mm²/s or more as measured at 100° C. can be used as a raw material of a vulcanized rubber having excellent rupture strength and low tan δ even when compared to a rubber composition for pneumatic tires containing unused process oil.

In the present invention, the recycled process oil is preferably
(ii) recycled process oil having a number average molecular weight of 500 and a weight average molecular weight of 600 or more,
(iii) recycled process oil containing 50% or more of a paraffin component and having a flash point of 250° C. or higher, or
(iv) recycled process oil having a glass transition point of higher than −80° C. This is because when containing such recycled process oil, the rubber composition for pneumatic tires can be used as a raw material of a vulcanized rubber having excellent rupture strength and low tan δ.

Further, in the present invention, the recycled process oil is more preferably
(v) recycled process oil derived from compressor operating oil. This is because when containing such recycled process oil, the rubber composition for pneumatic tires can be used as a raw material of a vulcanized rubber having more excellent rupture strength and lower tan δ.

### DETAILED DESCRIPTION OF THE PREFERRED EMBODIMENTS

A rubber composition for pneumatic tires according to the present invention contains recycled process oil. The recycled process oil herein means process oil obtained by recycling process oil that has been used at least once as an industrial lubricant. Examples of the industrial lubricant include compressor operating oil used for friction reduction or cooling during operation of compressors, electrical insulating oil that plays a role in insulating and cooling electrical devices such as transformers, cables, and condensers, and metal working oil used for friction reduction or cooling during cutting and processing of metals and the like. In the present invention, particularly, compressor operating oil-derived recycled process oil produced by recycling compressor operating oil is more preferred because when containing such recycled process oil, the rubber composition for pneumatic tires can be used as a raw material of a vulcanized rubber having more excellent rupture strength and lower tan δ.

The recycled process oil can be produced by, for example, recycling the above-described used industrial lubricant through dehydration, oxide removal, filtration, etc. It should be noted that in the present invention, the recycled process oil may contain an antioxidant added during, for example, a recycling process.

When containing recycled process oil whose kinematic viscosity as measured at 100° C. is 5 mm²/s or more, the rubber composition for pneumatic tires can be used as a raw material of a vulcanized rubber having excellent rupture strength and low tan δ. Particularly, the recycled process oil to be used more preferably has a kinematic viscosity of 10 mm²/s or more or 15 mm²/s or more as measured at 100° C. because a vulcanized rubber having more excellent rupture strength and lower tan δ can be produced. A method for measuring the kinematic viscosity of the recycled process oil will be described later.

In the present invention, the recycled process oil is preferably
(ii) recycled process oil having a number average molecular weight of 500 and a weight average molecular weight of 600 or more,
(iii) recycled process oil containing 50% or more of a paraffin component and having a flash point of 250° C. or higher, or
(iv) recycled process oil having a glass transition point of higher than −80° C. This is because when containing such recycled process oil, the rubber composition for pneumatic tires can be used as a raw material of a vulcanized rubber having excellent rupture strength and low tan δ. Methods for measuring the number average molecular weight and weight average molecular weight, the component ratio of a paraffin component or the like in oil, the flash point, and the glass transition point of the recycled process oil will be described later.

From the viewpoint of producing a vulcanized rubber having excellent rupture strength and low tan δ, the content of the recycled process oil in the rubber composition for pneumatic tires according to the present invention is preferably 1 to 20 parts by mass, more preferably 10 to 20 parts by mass per 100 parts by mass of the entire amount of a rubber component.

The rubber composition for pneumatic tires according to the present invention contains, in addition to the recycled process oil, a diene-based rubber as a rubber component. Examples of the diene-based rubber include emulsion-polymerized polystyrene butadiene rubber (hereinafter also referred to as “E-SBR”) obtained by emulsion polymerization (radical polymerization) in water, solution-polymerized styrene butadiene rubber such as solution-polymerized polystyrene butadiene rubber (hereinafter also referred to as “S-SBR”), natural rubber, isoprene rubber, and butadiene rubber.

The rubber composition for pneumatic tires according to the present invention may contain carbon black as a filler. Examples of the carbon black that can be used include: carbon blacks usually used in the rubber industry, such as SAF, ISAF, HAF, FEF, and GPF; and conductive carbon blacks such as acetylene black and ketjen black. The amount of the carbon black contained in the rubber composition for pneumatic tires according to the present invention is preferably 1 to 60 parts by mass, more preferably 30 to 60 parts by mass per 100 parts by mass of the entire amount of the rubber component.

Further, silica is also preferably contained as a filler. Examples of the silica to be used include silicas usually used for rubber reinforcement, such as wet silica, dry silica, sol-gel silica, and surface-treated silica. Among these, wet silica is preferred. The content of the silica is preferably 1 to 150 parts by mass, more preferably 50 to 100 parts by mass per 100 parts by mass of the entire amount of the rubber component.

When silica is contained as a filler, a silane coupling agent is also preferably contained. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. The content of the silane coupling agent is preferably 1 to 20 parts by mass, more preferably 1 to 10 parts by mass per 100 parts by mass of the silica.

The rubber composition for pneumatic tires according to the present invention may further contain, in addition to the diene-based rubber, the recycled process oil, the carbon black, the silica, and the silane coupling agent, a vulcanization-type compounding agent, an antiaging agent, stearic acid, a softener such as wax or oil, a processing aid, etc.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

Examples of the vulcanization-type compounding agent include a vulcanizing agent such as sulfur or an organic peroxide, a vulcanization accelerator, a vulcanization accelerator aid, and a vulcanization retarder.

The sulfur as the vulcanization-type compounding agent is not limited as long as it is sulfur usually used for rubber, and examples of such sulfur that can be used include powdered sulfur, precipitated sulfur, insoluble sulfur, and highly-dispersible sulfur. When rubber physical properties and durability after vulcanization are taken into consideration, the content of the sulfur is preferably 1 to 10 parts by mass, more preferably 1 to 5 parts by mass in terms of sulfur content per 100 parts by mass of the entire amount of the rubber component.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

The rubber composition for pneumatic tires according to the present invention is obtained by kneading, in addition to the diene-based rubber, the recycled process oil, the carbon black, the silica, and the silane coupling agent, the vulcanization-type compounding agent, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a sulfur-based vulcanizing agent and a vulcanization accelerator are previously kneaded to prepare a master batch, the remaining component is added to the master batch, and the mixture is further kneaded, a method in which components are added in any order and kneaded, and a method in which all the components are added at the same time and kneaded.

The rubber composition for pneumatic tires according to the present invention contains sustainable recycled process oil and is therefore useful for pneumatic tires considering environmental issues. Further, a pneumatic tire including at least a vulcanized rubber of the rubber composition for pneumatic tires according to the present invention has excellent rupture strength and low tan δ as well as sustainability. Therefore, the rubber composition for pneumatic tires according to the present invention is particularly useful for treads of pneumatic tires.

### EXAMPLES

Hereinbelow, the configuration and effect of the present invention will be described with reference to specific examples etc. It should be noted that in examples etc., evaluation items were evaluated on the basis of the following evaluation criteria using rubber samples obtained by heating and vulcanizing rubber compositions at 160° C. for 20 minutes.

### Rupture Strength of Vulcanized Rubber

A tensile test (Dumbbell No. 3) was performed in accordance with JIS K6251 to measure the rupture strength of a vulcanized rubber. In Comparative Examples 2 and 3 and Example 1, the evaluation result was expressed as an index number by taking the value of Comparative Example 1 as 100, in Comparative Examples 5 and 6 and Example 2, the evaluation result was expressed as an index number by taking the value of Comparative Example 4 as 100, and in Comparative Examples 8 and 9 and Example 3, the evaluation result was expressed as an index number by taking the value of Comparative Example 7 as 100. A larger index number indicates that the vulcanized rubber has more excellent rupture strength.

### Tan δ of Vulcanized Rubber

Measurement samples of a vulcanized rubber molded to have a predetermined shape were prepared, and the storage elastic modulus (E′) and loss elastic modulus (E′″) of the vulcanized rubber were measured by a dynamic viscoelasticity measuring device (product name “Fully Automatic Viscoelasticity Analyzer VR-7110”, manufactured by Ueshima Seisakusho Co., Ltd.) to determine tan δ at 0° C. In Comparative Examples 2 and 3 and Example 1, the evaluation result was expressed as an index number by taking the value of Comparative Example 1 as 100, in Comparative Examples 5 and 6 and Example 2, the evaluation result was expressed as an index number by taking the value of Comparative Example 4 as 100, and in Comparative Examples 8 and 9 and Example 3, the evaluation result was expressed as an index number by taking the value of Comparative Example 7 as 100. A larger index number indicates that the vulcanized rubber has lower tan δ and makes a pneumatic tire more fuel-efficient. Measurement conditions are as follows.
Size of measurement sample: length 40 mm, width 3 mm, thickness 2 mm
Measurement mode: tensile mode
Measurement temperature: 0° C., 60° C.
Frequency: 100 Hz
Dynamic strain: 0.15%

### Recycled Process Oil

The following three types of recycled process oils were prepared.
Recycled process oil 1: Recycled process oil obtained by recycling compressor operating oil used for friction reduction or cooling during operation of compressors through dehydration, oxide removal, filtration, etc., and containing an antioxidant.
Recycled process oil 2: Recycled process oil obtained by recycling electrical insulating oil that plays a role in insulating and cooling electrical devices such as transformers, cables, and condensers through dehydration, oxide removal, filtration, etc.
Recycled process oil 3: Recycled process oil obtained by recycling metal working oil used for friction reduction or cooling during cutting and processing metals and the like through dehydration, oxide removal, filtration, etc.

The kinematic viscosity, the number average molecular weight and weight average molecular weight, the proportion of a paraffin component in process oil, the flash point, and the glass transition point of each of the above recycled process oils 1 to 3 and unused process oil 1 (trade name “Process P200”, manufactured by JX Nippon Oil & Energy Corporation) as unused process oil were measured by the following methods.

### Kinematic Viscosity of Recycled Process Oil

In accordance with JIS K2283, kinematic viscosity (mm²/s) at 100° C. and kinematic viscosity at 40° C. were measured.

(Number average molecular weight (Mn) and weight average molecular weight (Mw) of recycled process oil)

The number average molecular weight and the weight average molecular weight were measured by GPC. Measurement conditions are as follows.
Column temperature: 40° C.
Mobile phase: tetrahydrofuran
Flow rate: 1.0 ml/min
Columns: Plgel 5 μm 500 Å+100 Å+50 Å(three columns)
Injection amount: 40 μL
Sample concentration: 2 g/L
Detector: RI

### Content of Paraffin Component in Process Oil of Recycled Process Oil

The content of a paraffin component in process oil was calculated by Kurtz method described in Journal of the Society of Rubber Science and Technology, Japan, Volume 50, No. 10 (1977).

### Flash Point of Recycled Process Oil

The flash point was measured in accordance with JIS K2283.

(Glass transition point (Tg (C)) of recycled process oil)

The glass transition point was measured at a temperature rise rate of 20° C./min using a differential scanning calorimeter [DSC] (product name: X-DSC 7000, manufactured by Hitachi High-Tech Corporation).

The physical properties of the recycled process oils 1 to 3 and the unused process oil 1 are shown in Table 1.

TABLE 1

| | Unused | Recycled | Recycled | Recycled |
|---|---|---|---|---|
| | process | process | process | process |
| | oil 1 | oil 1 | oil 2 | oil 3 |
| Density (15° C.) | 0.859-0.869 | 0.8807 | 0.8753 | 0.8723 |
| (g/cm³) | | | | |
| Kinematic viscosity | 2-3 | 20.27 | 2.554 | 2.981 |
| (100° C.) (mm²/s) | | | | |
| Kinematic viscosity | 25.2-35.2 | 222.5 | 9.293 | 12.26 |
| (40° C.) (mm²/s) | | | | |
| Flash point (° C.) | 200 or more | 280 | 142 | 174 |
| Paraffin component | 61-75 | 70.3 | 37.4 | 40.1 |
| content in oil (%) | | | | |
| Tg (° C.) | −83 | −68 | −96 | −96 |
| Mn | 490 | 880 | 270 | 310 |
| Mw | 530 | 1050 | 320 | 400 |
| Mw/Mn | 1.08 | 1.18 | 1.22 | 1.29 |

### Preparation of Rubber Compositions for Pneumatic Tires

Rubber compositions for pneumatic tires of Examples 1 to 3 and Comparative Examples 1 to 9 were prepared according to formulations shown in Tables 1 to 3 by kneading using a usual Banbury mixer. Compounding agents listed in Tables 1 to 3 are shown below (in Tables 1 to 4, the amount of each of the compounding agents added is expressed in parts by mass per 100 parts by mass of the rubber component).
SBR (E-SBR (emulsion-polymerized SBR)): trade name “SBR1502” (manufactured by ENEOS Materials Corporation)
NR (natural rubber): STR20.
BR (high cis-1, 4-polybutadiene): trade name “BR1280” (manufactured by LG Chem Ltd.)
Carbon black (CB) (HAF): trade name “N339 Seast KH” (manufactured by TOKAI CARBON CO., LTD.)
Silica: trade name “Nipsil AQ” (manufactured by Tosoh Corporation). Silane coupling agent: trade name “Si69” (manufactured by Degussa)
Wax: trade name “OZOACE0355” (manufactured by NIPPON SEIRO CO., LTD.)
Stearic acid: trade name “LUNAC S-20” (manufactured by Kao Corporation)
Zinc oxide: trade name “Zinc oxide grade 2” (manufactured by MITSUI MINING & SMELTING CO., LTD.)
Antiaging agent: trade name “NOCRAC 6C” (manufactured by OUCHI SHINKO CHEMICAL INDUSTRIAL CO., LTD.)
Vulcanization accelerator 1: trade name “NOCCELER D” (manufactured by OUCHI SHINKO CHEMICAL INDUSTRIAL CO., LTD.)
Vulcanization accelerator 2: trade name “SOXINOL CZ” (manufactured by SUMITOMO CHEMICAL COMPANY, LIMITED).
Sulfur: trade name “Powder Sulfur” (manufactured by Tsurumi Chemical Industry Co., ltd.)

TABLE 2

| | Comparative | Comparative | Comparative | |
|---|---|---|---|---|
| | Example 1 | Example 2 | Example 3 | Example 1 |
| SBR | 100 | 100 | 100 | 100 |
| CB | 15 | 15 | 15 | 15 |
| Silica | 50 | 50 | 50 | 50 |
| Silane coupling | 4 | 4 | 4 | 4 |
| agent | | | | |
| Unused | 10 | | | |
| process oil 1 | | | | |
| Recycled | | 10 | | |
| process oil 3 | | | | |
| Recycled | | | 10 | |
| process oil 2 | | | | |
| Recycled | | | | 10 |
| process oil 1 | | | | |
| Wax | 2 | 2 | 2 | 2 |
| Stearic acid | 2 | 2 | 2 | 2 |
| Antiaging agent | 2 | 2 | 2 | 2 |
| Zinc oxide | 2 | 2 | 2 | 2 |
| Vulcanization | 1.8 | 1.8 | 1.8 | 1.8 |
| accelerator 1 | | | | |
| Vulcanization | 1.3 | 1.3 | 1.3 | 1.3 |
| accelerator 2 | | | | |
| Sulfur | 1.8 | 1.8 | 1.8 | 1.8 |
| Rupture strength | 100 | 97 | 103 | 107 |
| tanδ 0° C. | 100 | 97 | 96 | 109 |

As can be seen from the results shown in Table 2, in the case of the rubber compositions for pneumatic tires containing 100 parts by mass of SBR as a rubber component, the vulcanized rubber of Example 1 containing the recycled process oil 1 was improved in both rupture strength and tan δ as compared to the vulcanized rubber of Comparative Example 1 containing the unused process oil. On the other hand, the vulcanized rubber of Comparative Example 3 containing the recycled process oil 2 was improved in rupture strength but deteriorated in tan δ as compared to the vulcanized rubber of Comparative Example 1 containing the unused process oil. The vulcanized rubber of Comparative Example 2 containing the recycled process oil 3 was deteriorated in both rupture strength and tan δ as compared to the vulcanized rubber of Comparative Example 1 containing the unused process oil.

TABLE 3

| | Comparative | Comparative | Comparative | |
|---|---|---|---|---|
| | Example 4 | Example 5 | Example 6 | Example 2 |
| SBR | 50 | 50 | 50 | 50 |
| NR | 50 | 50 | 50 | 50 |
| CB | 50 | 50 | 50 | 50 |
| Unused | 10 | | | |
| process oil 1 | | | | |
| Recycled | | 10 | | |
| process oil 3 | | | | |
| Recycled | | | 10 | |
| process oil 2 | | | | |
| Recycled | | | | 10 |
| process oil 1 | | | | |
| Stearic acid | 2 | 2 | 2 | 2 |
| Zinc oxide | 2 | 2 | 2 | 2 |
| Vulcanization | 1.5 | 1.5 | 1.5 | 1.5 |
| accelerator 2 | | | | |
| Sulfur | 1.5 | 1.5 | 1.5 | 1.5 |
| Rupture strength | 100 | 103 | 106 | 103 |
| tanδ 0° C. | 100 | 96 | 97 | 107 |

As can be seen from the results shown in Table 3, in the case of the rubber compositions for pneumatic tires containing 50 parts by mass of SBR and 50 parts by mass of NR as a rubber component, the vulcanized rubber of Example 2 containing the recycled process oil 1 was improved in both rupture strength and tan δ as compared to the vulcanized rubber of Comparative Example 4 containing the unused process oil. On the other hand, the vulcanized rubber of Comparative Example 6 containing the recycled process oil 2 and the vulcanized rubber of Comparative Example 5 containing the recycled process oil 3 were improved in rupture strength but deteriorated in tan δ as compared to the vulcanized rubber of Comparative Example 4 containing the unused process oil.

TABLE 4

| | Comparative | Comparative | Comparative | |
|---|---|---|---|---|
| | Example 7 | Example 8 | Example 9 | Example 3 |
| SBR | 80 | 80 | 80 | 80 |
| BR | 20 | 20 | 20 | 20 |
| CB | 50 | 50 | 50 | 50 |
| Unused | 10 | | | |
| process oil 1 | | | | |
| Recycled | | 10 | | |
| process oil 3 | | | | |
| Recycled | | | 10 | |
| process oil 2 | | | | |
| Recycled | | | | 10 |
| process oil 1 | | | | |
| Stearic acid | 2 | 2 | 2 | 2 |
| Zinc oxide | 2 | 2 | 2 | 2 |
| Vulcanization | 1.5 | 1.5 | 1.5 | 1.5 |
| accelerator 2 | | | | |
| Sulfur | 1.5 | 1.5 | 1.5 | 1.5 |
| Rupture strength | 100 | 94 | 97 | 102 |
| tanδ 0° C. | 100 | 99 | 95 | 104 |

As can be seen from the results shown in Table 4, in the case of the rubber compositions for pneumatic tires containing 80 parts by mass of SBR and 20 parts by mass of BR as a rubber component, the vulcanized rubber of Example 3 containing the recycled process oil 1 was improved in both rupture strength and tan δ as compared to the vulcanized rubber of Comparative Example 7 containing the unused process oil. On the other hand, the vulcanized rubber of Comparative Example 9 containing the recycled process oil 2 and the vulcanized rubber of Comparative Example 8 containing the recycled process oil 3 were deteriorated in both rupture strength and tan δ as compared to the vulcanized rubber of Comparative Example 7 containing the unused process oil.

What is claimed is:

1. A rubber composition for pneumatic tires containing recycled process oil, wherein the recycled process oil has a kinematic viscosity of 5 mm²/s or more as measured at 100° C.

2. The rubber composition for pneumatic tires according to claim 1, wherein the recycled process oil has a number average molecular weight of 500 and a weight average molecular weight of 600 or more.

3. The rubber composition for pneumatic tires according to claim 1, wherein the recycled process oil contains 50% or more of a paraffin component and has a flash point of 250° C. or higher.

4. The rubber composition for pneumatic tires according to claim 1, wherein the recycled process oil has a glass transition point of higher than −80° C.

5. The rubber composition for pneumatic tires according to claim 1, wherein the recycled process oil is derived from compressor operating oil.

6. A pneumatic tire comprising at least a vulcanized rubber of the rubber composition for pneumatic tires according to claim 1.
